(19) United States
(12) Patent Application Publication
(10) Pub. No.: US 2010/0021292 A1
(43) Pub. Date: Jan. 28, 2010

(54) FLUID DEFLECTOR FOR FLUID SEPARATOR DEVICES

(75) Inventors: William C. Maier, Almond, NY (US); Gocha T. Chochua, Olean, NY (US)

Correspondence Address: HAYNES AND BOONE, LLP;IP Section, 2323 Victory Avenue, Suite 700, Dallas, TX, 75219, US

(73) Assignee: DRESSER-RAND COMPANY, Olean, NY (US)

(21) Appl. No.: 12/442,629

(22) PCT Filed: Sep. 25, 2007
(86) PCT No.: PCT/US07/20659

§ 371 Date: Mar. 24, 2009

Related U.S. Application Data
(60) Provisional application No. 60/847,010, filed on Sep. 25, 2006.

(51) Int. Cl. F03B 11/02; B01D 33/15

(52) U.S. Cl. 415/208.1; 210/512.1; 210/512.3

(57) ABSTRACT

A fluid deflector is for a fluid separator including a central axis and an enclosed wall having an open end and an inner circumferential separation surface extending about the axis to define an interior separation chamber. The fluid deflector includes a base disposeable proximal to the wall open end and having a central axis collinear with the separator axis. A plurality of vanes are connected with the base so as to be spaced circumferentially about the central axis. The vanes define a plurality of flow channels each bounded by a separate pair of adjacent vanes and having an inlet and an outlet. Each vane directs flow through a bounded channel generally radially inwardly from the channel inlet toward the channel outlet and generally circumferentially and radially outwardly from the channel outlet.

The present invention relates to fluid machinery, and more particularly to combination separator and compressor devices.

Centrifugal compressors are known and typically include one or more impellers mounted on a driven shaft and configured to pressurize gas drawn into a central inlet and to discharge the fluid radially outwardly through one or more outlets located at an outer circumferential perimeter thereof. In order to properly function, only gas should be directed into the compressor inlet, such that any liquids should be removed from a fluid stream prior to entry into the compressor. As such, compressors are often used in conjunction with a separator device to remove liquids from the fluid stream prior to entry into the compressor inlet.

Referring to FIG. 1, one type of separator is a static separator S that uses swirler vanes V in conjunction with a separation surface SS bounding an interior separation chamber C. The swirler vanes V cause a fluid stream F to generally swirl or rotate after passing therethrough in order to initiate the radial outward movement of heavier liquid particles. Typically, such swirler vanes V are formed as plurality of relatively short, substantially radially aligned plates, such that a radial gap G is defined between adjacent vanes V. After passing through the vanes V, the flow is directed or deflected by means of contact with a static member M of the compressor assembly (e.g., a diaphragm wall) and/or a rotary member R (e.g., a rotary separator drum) so as to flow within the separation chamber C. The liquid particles contacting the separation surface SS are separated out of the fluid stream for subsequent collection.

Although such static separators are generally effective, such devices function less than ideally under certain operating characteristics. Specifically, when there are concentrated portions of liquid within the fluid stream, these liquid portions may pass directly between the radial vanes V without being entrained within the swirled fluid stream for conveyance toward the separation surface as intended.

### SUMMARY OF THE INVENTION

In one aspect, the present invention is a fluid deflector for a fluid separator, the separator including a central axis and a generally enclosed wall having an open end and an inner circumferential separation surface extending circumferentially about the axis so as to define an interior separation chamber. The fluid deflector comprises a base disposeable generally proximal to the wall open end and having a central axis, the base axis being at least generally collinear with the separator axis. A plurality of vanes are connected with the base so as to be spaced circumferentially about the central axis. Each vane is configured to direct fluid contacting the vane at least generally radially outwardly toward the wall separation surface.

In another aspect, the present invention is a fluid separator comprising a housing having an interior chamber and an inlet passage extending into the chamber, a wall disposed within the housing chamber and having an end surface and an inner circumferential surface at least partially defining a separation chamber, and a fluid deflector. The fluid deflector is disposed within the housing chamber and includes a base with a central axis, the base being spaced from the wall end surface so as to define a generally radial part configured to fluidly connect the inlet passage with the separation chamber, and a plurality of vanes connected with the base. The vanes are spaced circumferentially about the central axis and each vane is configured to direct fluid contacting the vane generally toward the wall inner surface. As such, at least a portion liquid and/or relatively dense gas within fluid that is directed onto the wall inner surface is separated from the fluid.

In a further aspect, the present invention is a compressor comprising a casing having an interior chamber and an inlet passage extending into the chamber, a shaft disposed within the casing chamber so as to be rotatable about a central axis, and a least one impeller mounted on the shaft. An enclosed wall is disposed within casing chamber and has an end surface and an inner surface extending circumferentially about the axis and spaced radially outwardly from the shaft. The wall inner surface at least partially defines a separation chamber. Further, a fluid deflector is disposed within the housing chamber generally between the wall end surface and the impeller. The deflector includes a base with a central axis, the base being spaced from the wall end surface so as to define a generally radial port configured to fluidly connect the inlet passage with the separation chamber. A plurality of vanes are connected with the base and are spaced circumferentially about the central axis. Each vane is configured to direct fluid contacting the vane generally toward the wall inner surface such that at least a portion of liquid and/or relatively dense gas within fluid directed onto the wall inner surface is separated from the fluid.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a broken-away, axial cross-sectional view of a prior art static separator device of a combination separator compressor device, showing a known swirl device;

FIG. 2 is a broken-away, axial cross-sectional view of a static separator with a fluid deflector in accordance with the present invention;

FIG. 3 is a perspective view of the fluid deflector, shown without a base shroud member;

FIG. 4 another perspective view of the fluid deflector, shown with the base shroud member;

FIG. 5 is a radial side plan view of the fluid deflector;

FIG. 6 is a radial cross-sectional view of the fluid deflector taken through line 6-6 of FIG. 5;

FIG. 7 is an axial cross-sectional view of the fluid deflector taken through line 7-7 of FIG. 5;

FIG. 8 is an axial front plan view of the fluid deflector;

FIG. 9 is an axial front plan view of the fluid deflector, shown without the shroud member and with a separator wall inner surface in phantom;

FIG. 10 is an axial cross-section view of the fluid deflector shown without the shroud member;

FIG. 11 is a cross-section view of the fluid deflector taken through a plane spaced from and parallel to a base axis;

FIG. 12 is an enlarged, broken-away radial cross-sectional view of the fluid deflector;

FIG. 13 is an enlarged, broken-away perspective view of the fluid deflector, shown without the shroud member;

FIG. 14 is a duplicate view of FIG. 10, shown with flow paths through one flow channel;

FIG. 15 is a duplicate view of FIG. 11, shown with flow paths through one flow channel; and

FIG. 16 is a more detailed view of FIG. 16, shown with flow paths through one flow channel.

### DETAILED DESCRIPTION OF THE INVENTION

Certain terminology is used in the following description for convenience only and is not limiting. The words “right”, left”, “lower”, “upper”, “upward”, “down” and “downward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. Further, as used herein, the word “connected” is intended to include direct connections between two members without any other members interposed therebetween and indirect connections between members in which one or more other members are interposed therebetween. The terminology includes the words specifically mentioned above, derivatives thereof, and words of similar import.

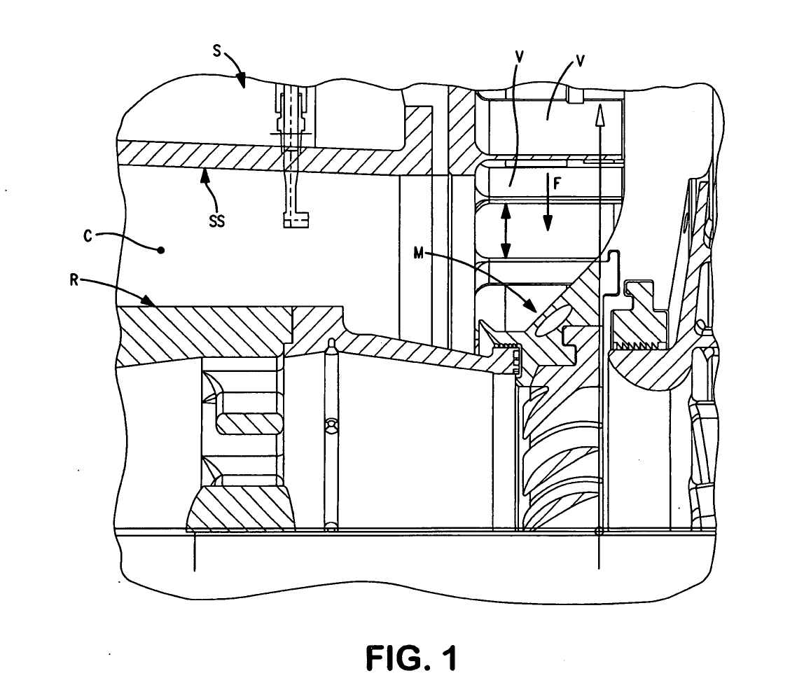

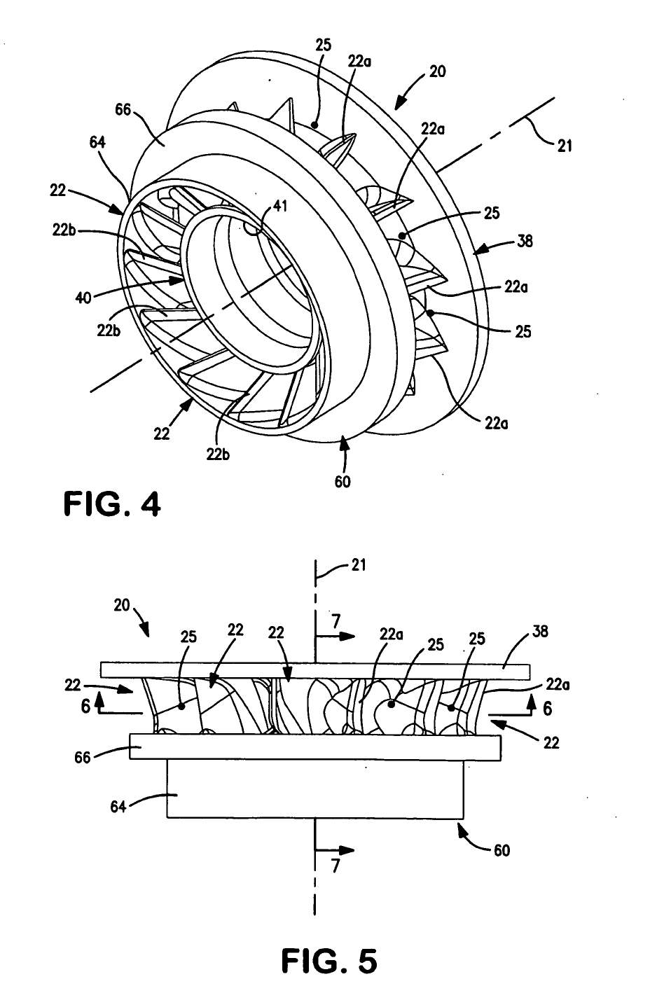

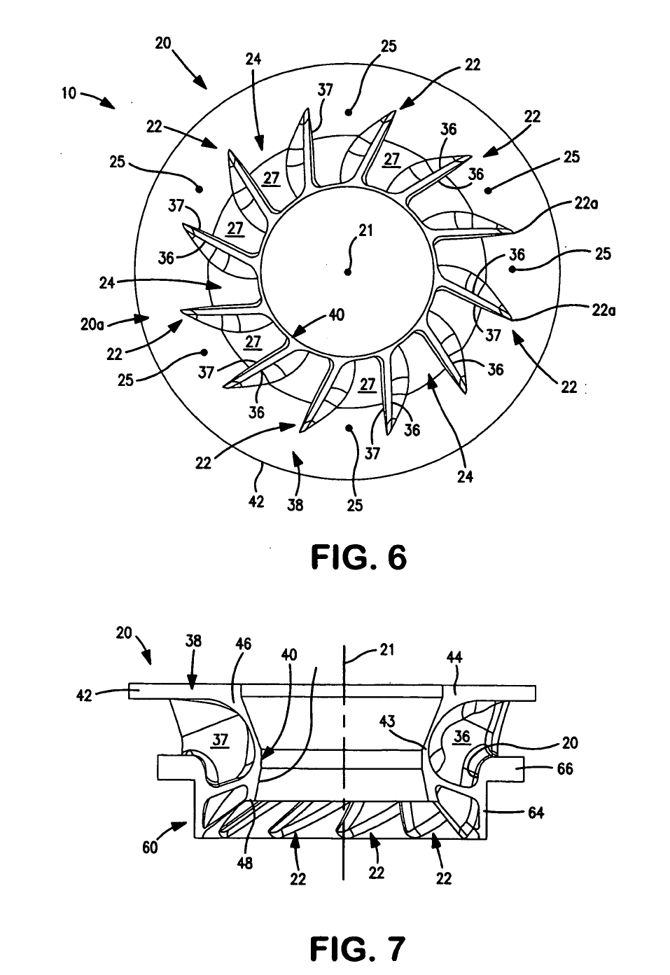

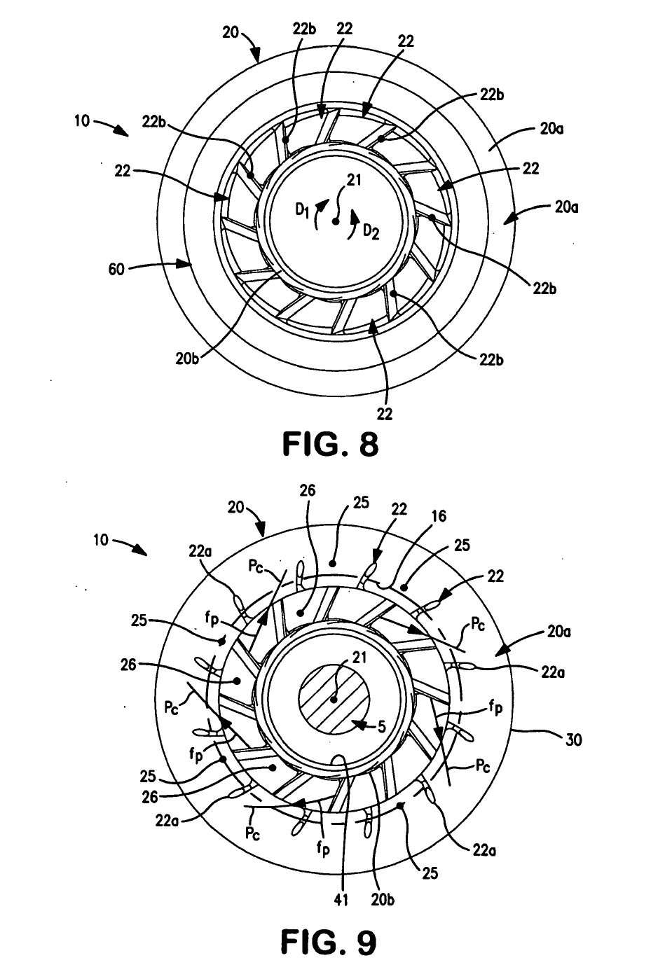

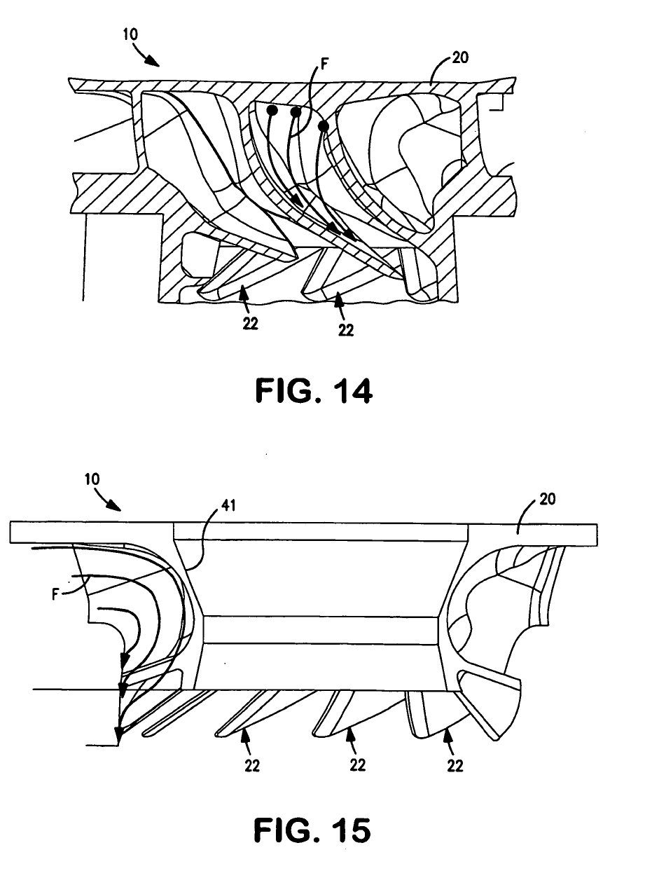

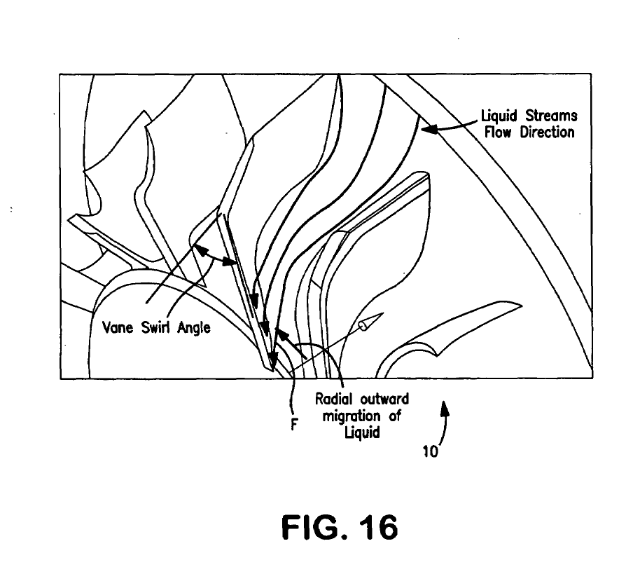

Referring now to the drawings in detail, wherein like numbers are used to indicate like elements throughout, there is shown in FIGS. 1-16 a fluid deflector 10 for a fluid separator 12. The separator 12 includes a central axis 11 and generally enclosed wall 14 with at least one open, inlet end 15 with an end surface 15a and an inner circumferential separation surface 16. The separation surface 16 extends circumferentially about the axis 11 so as to define an interior separation chamber 17. The separator 12 is preferably installed within, or is a subassembly of, a compressor 1 as discussed below, but may alternatively be a “stand alone” fluid separation device. The fluid deflector 10 basically comprises a base 20 and a plurality of vanes 22 connected with the base 20. The base 20 is disposeable proximal to the wall open end 15 and has a central axis 21, the base axis 21 being at least generally collinear with separator axis 11 when the base 20 is positioned as intended. The plurality of vanes 22 are connected with the base 20 so as to be spaced circumferentially about the central axis 15. Further, each vane 22 is configured to direct fluid contacting the vane 22 at least generally radially outwardly toward the separator wall inner surface/separation surface 16. Thereby, at least a portion of liquid and/or relatively dense gas within a fluid stream F directed onto the wall inner surface 16 is separated from the remaining fluid (i.e., which is substantially gaseous).

More specifically, the base 20 and the plurality of vanes 22 define a plurality of flow channels 24, each flow channel 24 being bounded by a separate one of a plurality of pairs of adjacent vanes 22. Also, each flow channel 24 has an inlet 25 and an outlet 26, as described in further detail below. Each vane 22 is configured to direct flow through at least one channel 24 partially bounded by the vane 22 such that fluid flows generally radially inwardly from the channel inlet 24 toward the channel outlet 26, and then flows generally circumferentially and radially outwardly from the channel outlet 26. That is, each vane 22 is configured to direct fluid contacting the vane 22 to flow at least generally radially outwardly from the outlet 26 from one of the two channels 24 partially bounded by the vane 22, as described in further detail below. Further, the base 20 has an outer surface 23 facing generally toward the separator wall 14 and each vane 22 extends generally outwardly from the base surface 23, each flow channel 24 being partially bounded by a separate one of a plurality of flow surface sections 27 of the base surface 23.

In other words, a plurality of flow surface sections or “flow surfaces” 27 are each defined between a separate pair of adjacent vanes 22 and partially bound a separate one of the flow channels 24. Each flow surface 27 is configured to direct fluid contacting the surface 27 first generally radially inward from the inlet 25 and then radially outwardly from the outlet 26. As such, with the plurality of circumferentially spaced channel outlets 26 each directing a separate fluid stream portion f_{P} radially outwardly in a separate circumferential and axial, generally spiral-shaped path P_{C} (see FIG. 9), a swirling fluid stream F is generated within the separator inner chamber 17, causing liquid portions (and/or dense gas portions) of the swirling stream F to be directed onto the separation surface 16 so as to be removed from the fluid stream F prior to flowing out of a chamber outlet 18.

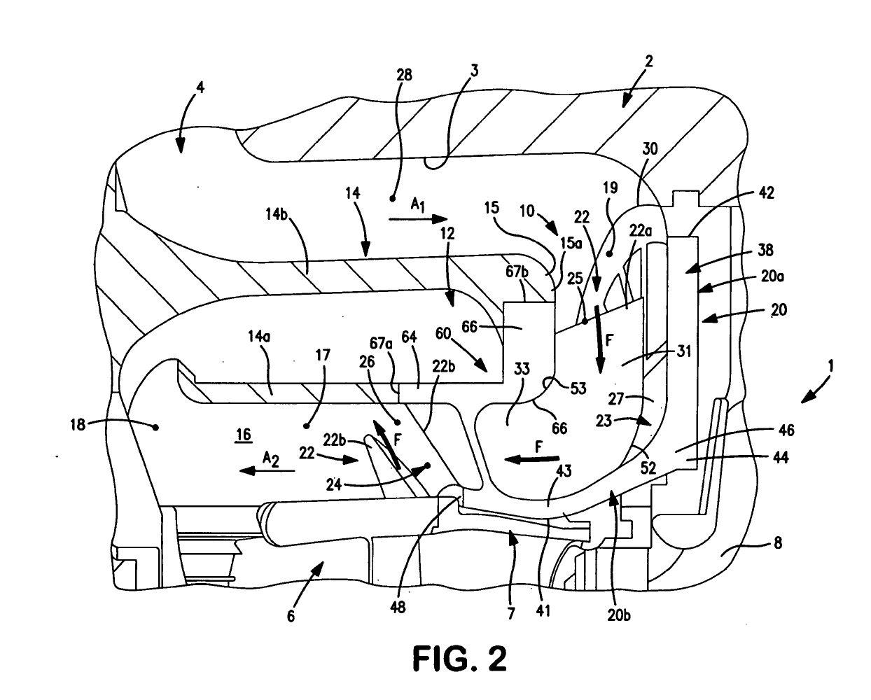

Preferably, the separator 12 is incorporated into a compressor 1 that further includes a casing 2 with an interior chamber 3 and an inlet passage 4 extending into the chamber 3. The base 20 is spaced from the separator wall end 15 so as to define a generally radial port 19 configured to fluidly connect the inlet passage 4 with the separation chamber 17. As shown in FIG. 2, the separator enclosed wall 14 preferably includes an inner wall section 14a providing the separation surface 16 and a coaxial outer wall section 14b spaced radially outwardly from the inner wall section 14a and partially defining an annular flow passage section 28 (discussed below) of the inlet passage 4, but may alternatively be formed as a single, radially thicker wall (not shown). Further, the base 20 preferably has an outer, generally radial portion 20a spaced from the wall end 15, such that the port 19 is defined between the base radial portion 20a and the wall end 15, and an inner, generally axial portion 20b extending axially from the radial portion 20b so as to be disposed at least partially within the separation chamber 17.

With this structure, each vane 22 preferably has a first or inlet end 22a located at least generally proximal to, and preferably disposed within, the flow port 19 and a second or outlet end 22b spaced axially and radially inwardly from the first end 22a and disposed within the separator interior chamber 17. More specifically, each vane 22 is located with respect to the separator wall 14 such that the vane first end 22a is spaced axially outwardly from the separator wall end 15 and the vane second end 22b is spaced axially inwardly from the wall end 15. As such, a fluid stream F contacting each vane 22 is directed to flow generally radially inwardly from the vane first end 22a, then generally axially into the wall interior chamber 17, and thereafter radially outwardly from the vane second end 22b so as to flow both circumferentially and radially outwardly generally toward the wall inner surface 16.

Further, the annular flow passage section 28 of the inlet passage 4 is preferably defined between the casing 2 and the separator wall 14, so as to extend entirely circumferentially about the wall 14, and extends at least generally along the separator axis 11. Also, the base 20 and/or the vanes 22 are configured to deflect fluid F flowing generally in a first axial direction A₁ through the annular passage section 28 (and also circumferentially therethrough) to flow generally in an opposing axial direction A₂ into the interior chamber 17. Thus, the fluid deflector 10 not only generates swirl within the fluid stream F passing therethrough and directs the liquid portions toward the separation surface 16, but also functions to deflect or channel the fluid stream F to flow axially into the separation chamber 17.

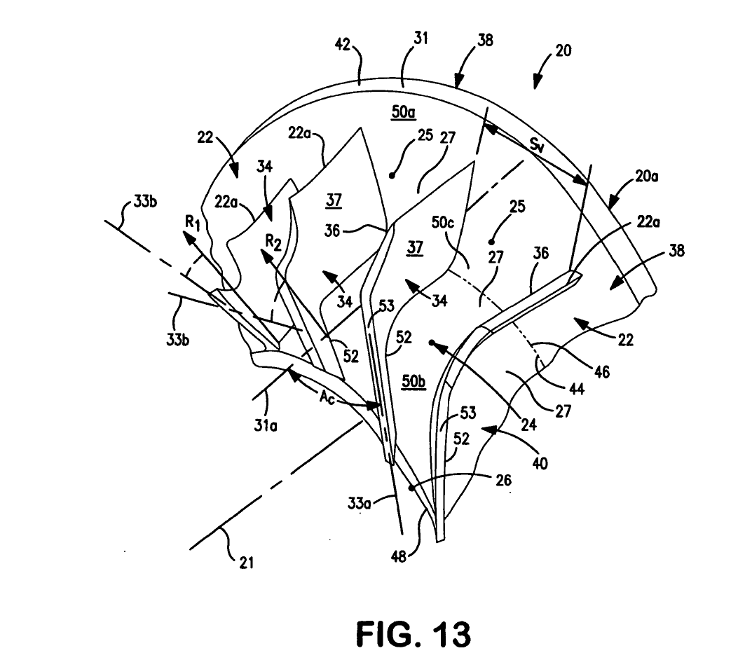

Referring to FIGS. 24 and 13, the deflector base 20 has an outer circumferential edge 30 on the base radial portion 20a, which extends circumferentially about the axis 21, and each vane 22 has a first, generally radial portion 31 providing the inlet or leading end 22a and a second, generally axial portion 33 providing the outlet or trailing end 22b. Each vane radial portion 31 is disposed generally proximal to the base outer edge 30 and extends generally radially inwardly from the inlet end 22a. Further, each vane axial portion 33 is connected with, and preferably integrally formed with, the associated radial portion 31 and extends generally axially and circumferentially from the first portion 31 to the vane outlet end 22b, which is located generally proximal to the base axis 21. Preferably, each vane 22 includes an elongated body 34 with a first section 34a providing the radial portion 31, a second section 34b providing the axial portion 33, and opposing, curved channeling surfaces 36, 37 extending between the two ends 22a, 22b. Each channeling surface 36, 37 is configured to direct fluid contacting the vane body 34 proximal to the body first end 22a to flow generally radially inwardly and then simultaneously generally axially and generally radially outwardly beyond the vane second end 22b, as described in greater detail below.

Further, each vane body 34 is at least partially generally bended or curved so as to extend at least partially circumferentially about the base axis 21. That is, each vane body 34 is generally bended such that the body second section 34b is angled with respect to the body first section 34a so as to extend in a generally circumferential direction with respect to the axis 21, as described above. More specifically, as shown in FIG. 13, each vane body 34 is formed and arranged on the base 20 such that the vane radial portion 31 has a lateral centerline 31a that extends generally parallel with the axis 21 (i.e., between vane side edges 52, 53 as described below). Further, the vane axial portion 33 has a longitudinal centerline 33a that defines an angle AC with the respect to the radial portion centerline 31a (and thus the base axis 21), which is preferably about sixty degrees (60°).

As such, the body curvature (and orientation as described below) causes fluid flow F contacting the vane body 34 to be “turned” within the associated flow channels 24 so as to be directed generally radially outwardly from and circumferentially about the base axis 21 and toward the wall inner surface 17. Also, by having a curved/bended body 34 as described below, each vane axial portion 33 generally “overlaps” an inner portion of one fluid channel 24 partially defined by the vane 22, preferably by at least one half of the spacing or pitch S_{V} (FIG. 13) between the vanes 22, such that the channel outlet 26 is spaced laterally or circumferentially from the inlet 25. As such, fluid entering generally centrally through a channel inlet 25 cannot pass through without contacting at least the vane 22 which extends across the flow channel 24, which is preferably a pressure surface of the vane 22 as described below.

Furthermore, all of the vane bodies 34 of the plurality of vanes 22 are preferably arranged on the base 20 so as extend circumferentially in the same one of two opposing angular directions D₁ or D₂ (depicted in the D₁ direction—see FIG. 8) about the base axis 21. As such, the plurality of vanes 22 are collectively configured to direct fluid flow contacting each vane 22 to generally swirl in a circulating mass in the one angular direction D₁, D₂ about the base axis 21. However, the deflector 10 may alternatively be constructed such that some vanes 22 are circumferentially oriented in one angular direction D₁, D₂ and the remaining are orientated in the opposing direction D₂, D₁ (not preferred), causing the fluid stream F to flow in a turbulent stream.

Referring to FIGS. 2, 3, 6, 7, 10 and 13, the base 20 is preferably generally circular and radially symmetric about the axis 21 and includes a generally disk-like outer portion 38 providing the base radial portion 20a and a generally tubular inner portion 40 providing the base axial portion 20b and having a central bore 41. The disk-like or disk portion 38 is generally shaped like a circular ring, has a circular outer circumferential edge 42 providing the body outer edge 30 described above, and further has an inner circumferential edge 44 spaced radially inwardly from the outer edge 30. The disk portion 38 is preferably fixedly connected with the casing 2 such that the fluid deflector 10 is immovably mounted within a casing chamber 3, as shown in FIG. 2.

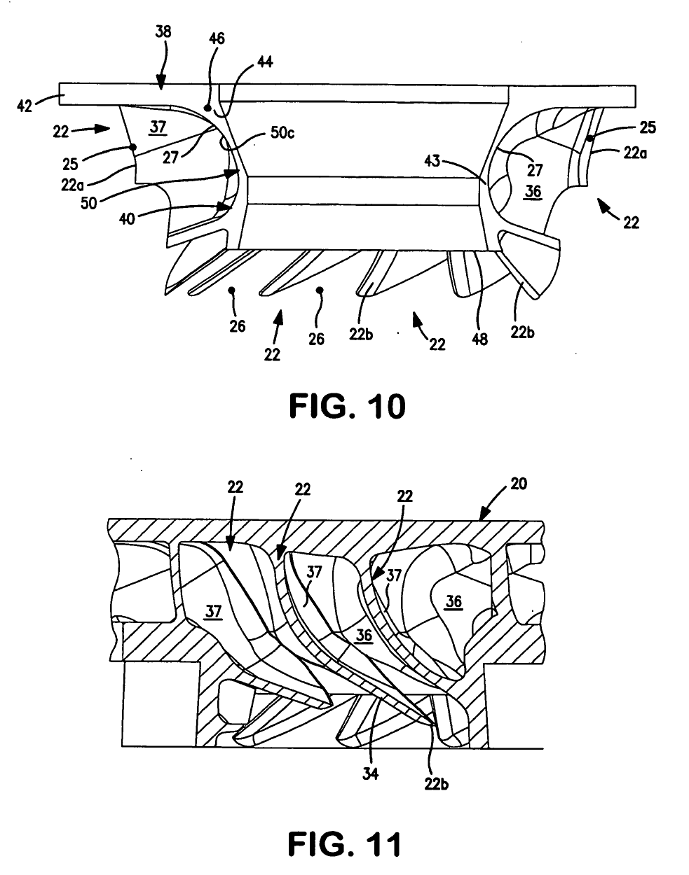

Further, the generally tubular inner portion or “hub” portion 40 is generally circular and has a first axial end 46 connected with, preferably integrally formed with, the disk inner edge 44 and an opposing, second or outer axial end 48 spaced axially from the disk portion 38. The base hub portion 40 is at least partially disposeable within the separator interior chamber 17, such that fluid contacting the base portion 20 is directed into the chamber 17 by the hub portion 40. As best shown in FIGS. 2 and 10, the hub portion 40 preferably has a generally concave outer surface portion 43 extending axially between the two hub ends 46, 48, such that the base flow surface 27 of each flow channel 24 extends radially inwardly and then radially outwardly in a direction toward the channel outlet 26. As such, fluid contacting or flowing along the base flow surfaces 27 at/through the concave surface section 43 is directed generally radially outwardly from the hub second, outer end 48.

With the preferred two-portion structure described above, the base outer surface 23 is generally “complex-shaped” and has a generally radial section 50a extending generally radially on the base outer disk portion 38 and a generally circumferential section 50b extending generally axially on the base inner tubular portion 40, which includes the concave surface portion 43. The two base surface sections 50a, 50b are joined or blended through a generally concavely curved section 50c at the intersection or conjunction of the two base portions 38, 40. Further, the vanes 22 are connected with, and preferably integrally formed with, the base outer surface 50, such that the vanes 22 generally follow the contour of the base outer surface 50. Specifically, each vane radial portion 31 extends generally radially between the disk portion outer and inner edges 42, 44 and the connected vane axial portion 33 extends generally axially (and circumferentially) between the hub portion inner and outer axial ends 46, 48.

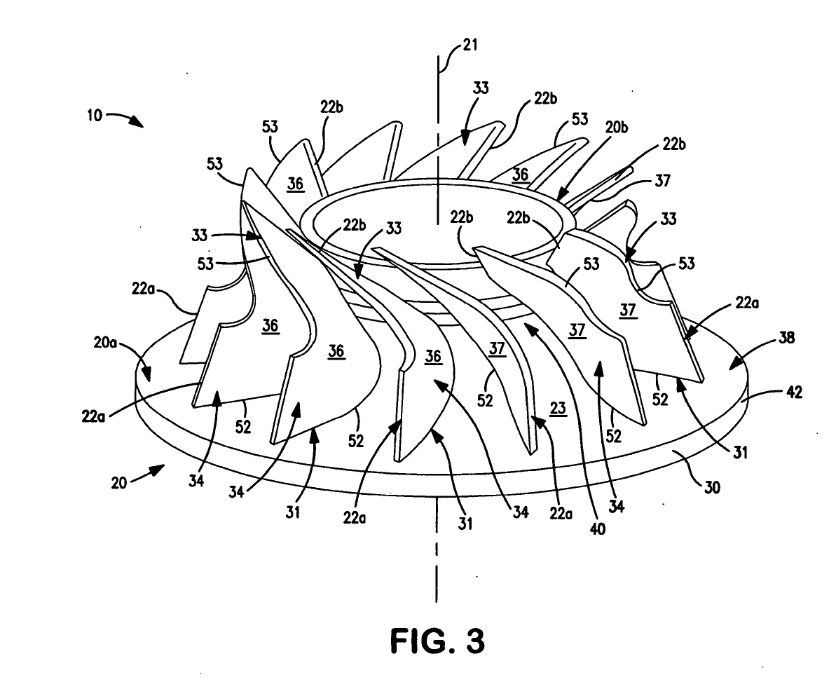

Referring to FIGS. 3, 6, 12 and 13, each vane 22 is configured such that the one channeling surface 36 is a suction surface and the other channeling surface 37 is a pressure surface. Each vane suction surface 36 faces generally toward the pressure surface 36 of one of the two adjacent vanes 22 such that the facing suction and pressure surfaces 36, 37 partially bound one of the plurality of flow channels 24. Further, each vane body 34 is preferably generally curved, as discussed above, such that the suction surface 36 of one vane 22 is configured to direct fluid onto the facing pressure surface 27 of one adjacent vane 22. More specifically, each vane body 34 has a generally uniform thickness t_{B} and is formed such that the suction surface 36 is generally convex and the pressure surface 27 is generally concave. As such, fluid (particularly liquid) contacting the suction surface 36 is directed generally away or deflected from the surface 36 and toward the pressure surface 37, and fluid contacting the pressure surface 37 tends to be retained to flow therealong. Furthermore, each vane 22 is angled with respect to the base 20 such that the pressure surface 37 of the vane 22 faces generally toward the separator wall inner surface 16, as described in further detail below.

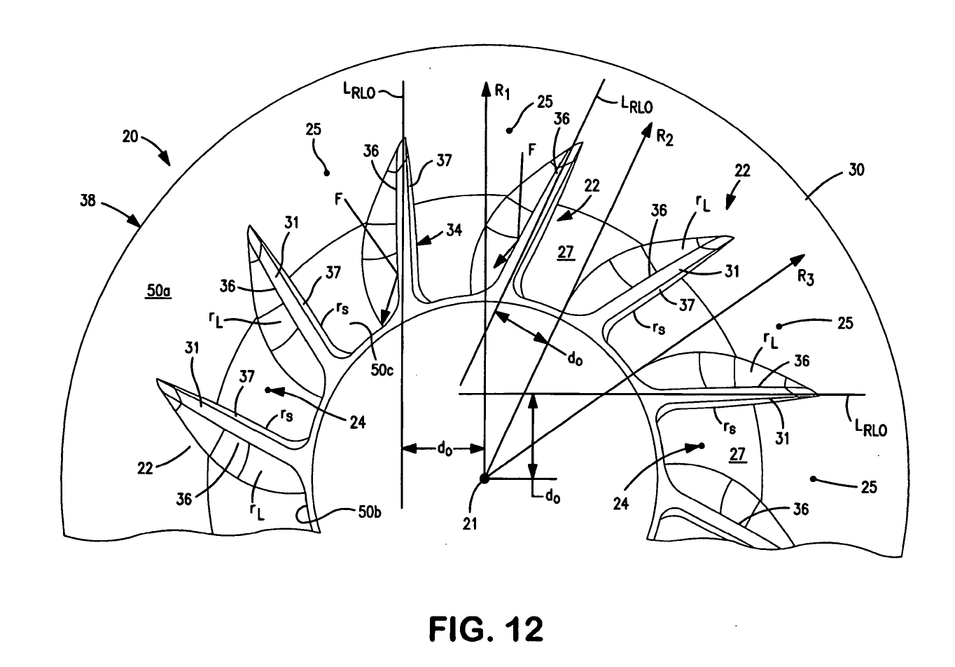

As best shown in FIG. 12, each vane 22 is preferably arranged or oriented on the base 20 such that the vane radial portion 31 only extends generally radially with respect to the base axis 21 and not substantially or precisely radially. More specifically, each vane radial portion 31 is generally angled with respect to radial lines R_{N} (e.g., R₁, R₂, etc.) through the base axis 21, such that a longitudinal centerline L_{RLO} of the radial portion 31 is spaced or offset by a perpendicular distance d_{O} from base axis 21, so that the vane suction surface 36 faces generally toward the base outer circumferential perimeter or edge 30 (i.e., toward the associated channel inlet 25). As such, fluid flowing through one of the two inlets 25 associated with each vane 22 contacts the vane suction surface 36 and is deflected generally toward the facing pressure surface 37 of one of the two adjacent vanes 22, as depicted in FIG. 12.

Referring to FIGS. 2, 3, and 13, each vane body 34 also has first and second side edges 52, 53 extending generally longitudinally between the vane inlet and outlet ends 22a, 22b. The first edge 52 is connected with the base outer surface 50 and the second edge 53 is spaced from the base 20 (and connected with a base shroud 60 described below), the second edge 53 extending generally parallel with the first side edge 52. Preferably, the vane first side edges 52 are connected or joined with the base 20 such that a relatively large fillet radius r_{L} extends between the each vane suction surface 36 and the base outer surface 50, but a rather small fillet radius r_{S} extends between each pressure surface and the base surface 50, as indicated in FIG. 12. As such, the large fillet radius r_{L} further assists the channeling or direction of fluid contacting each vane suction surface 36 toward the facing pressure surface 37.

Referring particularly to FIG. 13, each vane body 34 is preferably angled with respect to at least the outer surface section 50b of the base tubular portion 40 such that the vane second side edge 53 is angled or offset circumferentially with respect to the vane first side edge 52 (and thus also the base surface section 50b) so that the vane pressure surface 37 faces generally away from the base axis 21 in order to direct liquid flowing on the pressure surface 37 generally radially outwardly. In other words, at least the axial portion 33 of each vane 22 is angled with respect to the base surface section 50b such that a lateral centerline 33b extending centrally through the first and second edges 52, 53 intersects with radial lines R_{N} (e.g., R₁, R₂, etc.) through the base axis 21 and is nonintersecting with (i.e., spaced perpendicularly from) the base axis 21, so that the vane pressure surface 37 faces generally toward the separator wall inner surface 17.

Referring to FIGS. 2, 4, 5, 7 and 8, the fluid deflector 10 preferably further comprises a base shroud member 60 including a generally tubular portion. 64 spaced radially outwardly from the base tubular portion 40 and a generally annular portion 66 spaced axially from the base disk portion 38. Each of the plurality of vanes 22 is connected with the shroud member 60, specifically the second side edges 53 thereof, such that each vane radial portion 31 extends generally axially between the base disk portion 38 and the shroud member annular portion 66 and each vane axial portion 33 extends generally radially between the base tubular portion 40 and the shroud member tubular portion 64. Although each vane 22 is preferably connected with or attached with both the base 20 and the shroud member 60, most preferably integrally formed with both, the vanes 22 may alternatively be connected with only the shroud member 60, such that the vane first side edges 52 are merely disposed against the base surface 23, or may be connected only with the base 20 so that the second side edges 53 are disposed against, but unconnected with, the shroud 60. Further, the shroud member,60 has an inner surface 66 partially bounding the plurality of flow channels 24, as described above, and opposing end surfaces 67a, 67b which are separately disposeable against the preferred inner and wall sections 14a, 14b of the separator enclosed wall 14, as depicted in FIG. 2. Furthermore, although the shroud member 60 is preferred, the fluid deflector 10 may be constructed without the shroud member 66 and will still function generally as described herein.

Referring to FIGS. 2 and 9, the fluid deflector 10 is preferably used with a separator-compressor device 2 that further includes a drive rotor or shaft 5 extending through the casing 2 and a rotary separator 6 mounted on the shaft 5. The rotary separator 6 preferably includes a generally tubular drum 7 mounted on the shaft 5 and disposed within the separator wall 14 such that the separation chamber 17 is generally annular. As such, the bore 41 of the base hub portion 40 is preferably sized to receive the shaft 5 with clearance, such that the shaft 5 is rotatable within the base 20 (and deflector 10) while the base 20 remains stationary. Most preferably, a portion of the rotary separator drum 7 is disposed within the base opening 54, the opening 54 being sized such that the drum 7 also rotates within the immovable deflector base 20.

It will be appreciated by those skilled in the art that changes could be made to the embodiments described above without departing from the broad inventive concept thereof. It is understood, therefore, that this invention is not limited to the particular embodiments disclosed, but it is intended to cover modifications' within the spirit and scope of the present invention as generally defined in the appended claims.

1-40. (canceled)

41. A fluid deflector for a fluid separator, comprising:
a base disposeable proximate an open end of a substantially enclosed wall of the fluid separator and having a base central axis being substantially collinear with a separator central axis, wherein the substantially enclosed wall has an open end and an inner circumferential separation surface extending circumferentially about the axis so as to define an interior separation chamber; and
a plurality of vanes spaced circumferentially about the base central axis and connected with or disposed against the base, the vanes being configured to direct fluid contacting the vane radially outwardly toward the inner circumferential separation surface.

42. The fluid deflector as recited in claim 41, wherein the base and the plurality of vanes define a plurality of flow channels, each of the plurality of flow channels being bounded by a separate one of a plurality of pairs of adjacent vanes and having a channel inlet and a channel outlet, each vane being configured to direct flow through at least one channel partially bounded by the vane such that fluid flows radially inward from the channel inlet toward the channel outlet and circumferentially and radially outward from the channel outlet.

43. The fluid deflector as recited in claim 42, wherein the base has an outer surface facing toward the separator substantially enclosed wall, each vane extending outward from the base outer surface, each flow channel being partially bounded by a separate one of a plurality of flow sections of the base surface.

44. The fluid deflector as recited in claim 43, wherein the base includes a body with a tubular hub portion having first and second ends spaced apart along the base central axis and a disk-like portion extending radially outward from the first end of the hub portion, the hub portion being at least partially disposeable within the interior separation chamber and each base flow section extending radially along the base disk-like portion and axially along the hub portion so that fluid contacting a base flow section is directed radially inward and then axially and into the chamber toward the inner circumferential separation surface.

45. The fluid deflector as recited in claim 41, wherein each vane includes an elongated body extending at least partially along the base central axis and having first and second ends and opposing channeling surfaces extending between the first and second ends, wherein the first end is spaced axially outward from the open end of the substantially enclosed wall and the second end is spaced axially inward from the open end of the substantially enclosed wall so as to be disposed at least partially within the interior separation chamber, each channeling surface being configured to direct fluid contacting the elongated body proximal to the first end to flow radially inward and then simultaneously axially and radially outward beyond the second end.

46. The fluid deflector as recited in claim 45, wherein each vane body is at least partially curved so as to extend at least partially circumferentially about the base axis such that fluid flow contacting the vane body is directed radially outward from and circumferentially about the base central axis and toward the interior separation surface, and each vane elongated body has first and second side edges each extending between the vane first and second ends, the first side edge being disposed against the base and the second side edge being spaced from the base, the second side edge extending substantially parallel with the first side edge.

47. The fluid deflector as recited in claim 45, wherein the elongated body of each vane extends at least partially circumferentially in the same one of two opposing angular directions about the base central axis, wherein the plurality of vanes are configured to direct flow contacting at least two of the vanes to swirl in one of two opposing angular directions about the base central axis.

48. The fluid deflector as recited in claim 46, wherein the base includes a tubular portion with an outer circumferential surface, each vane first side edge is connected with the outer circumferential surface, and each vane is angled with respect to the outer circumferential surface such that the vane second side edge is offset circumferentially with respect to the vane first side edge.

49. The fluid deflector as recited in claim 46, further comprising a tubular shroud spaced radially outward from the base tubular portion, the second side edge of each vane being connected with the shroud.

50. The fluid deflector as recited in claim 45, wherein each vane is disposed between two adjacent vanes, one of the opposing channeling surfaces is a suction surface and the other opposing channeling surface is a pressure surface, each suction surface facing toward the pressure surface of one of the two adjacent vanes such that the facing suction and pressure surfaces partially bound one of the plurality of flow channels, each vane being angled such that the pressure surface of each vane faces toward the inner circumferential separation surface and each suction surface is configured to direct fluid contacting the suction surface toward the facing pressure surface, the vane suction surface faces toward an outer circumferential perimeter of the base so that fluid contacting the suction surface is deflected toward the facing pressure surface of one of the two adjacent vanes.

51. The fluid deflector as recited in claim 41, wherein the fluid separator further comprises:
a flow port adjacent to the open end of the substantially enclosed wall, wherein each vane has a first end located at least proximal to the flow port and a second end spaced axially and radially inwardly from the first end and disposeable within the interior separation chamber such that fluid contacting the vane is directed to flow radially inwardly from the vane first end, axially into the interior separation chamber, and radially outwardly from the vane second end toward the wall inner surface; and
a flow passage extending along the separator central axis, the flow port fluidly connecting the flow passage with the interior separation chamber, wherein at least one of the base and each vane is configured to deflect fluid flowing in a first axial direction through the flow passage to flow in an opposing second axial direction into the interior separation chamber.

52. The fluid deflector as recited in claim 41, wherein:
the substantially enclosed wall of the fluid separator is an inner wall and has an outer circumferential surface, wherein the fluid separator further includes another substantially enclosed wall with an inner circumferential surface being spaced radially outward from the inner wall outer circumferential surface so as to define an annular flow channel; and
the base is spaced axially from the inner wall end and extends radially toward the outer circumferential surface and has a portion disposed within the interior separation chamber such that fluid flowing through the annular flow channel contacts at least one of the base and at least one vane so as to be directed radially and then axially and circumferentially into the interior separation chamber.

53. The fluid deflector as recited in claim 52, wherein the fluid separator further includes a rotatable shaft and a rotary separator mounted on the shaft and disposed within the interior separation chamber, the base having a central opening sized to receive the rotatable shaft with clearance such that the rotatable shaft is rotatable with respect to the base.

54. The fluid deflector as recited in claim 53, wherein the fluid separator includes a casing, the outer circumferential surface being immovably mounted within the casing, the base is fixedly connected with the outer circumferential surface, and a portion of the rotary separator is disposed within the base opening, the central opening being sized such that the rotary separator is rotatable with respect to the base.

55. A fluid separator comprising:
a housing having an interior chamber and an inlet passage extending into the interior chamber;
an enclosed wall disposed within the interior chamber and having an end surface and an inner circumferential surface at least partially defining a separation chamber; and
a fluid deflector disposed within the interior chamber and including a base with a central axis, the base being spaced from the wall end surface so as to define a radial port configured to fluidly connect the inlet passage with the separation chamber, and a plurality of vanes spaced circumferentially about the base central axis, each vane being configured to direct fluid contacting the vane toward the wall inner circumferential surface such that at least a portion of at least one of liquid and relatively dense gas within a fluid directed onto the wall inner circumferential surface is separated from the fluid.

56. The fluid separator as recited in claim 55, further comprising:
a shaft disposed within the interior chamber so as to be rotatable about a central axis; and
a rotary separator mounted to the shaft and having an outer surface spaced radially inward from the wall inner circumferential surface such that the separation chamber is an annular primary chamber, the rotary separator having an inner surface extending about the shaft so as to define an inner separation chamber and at least one outlet passage fluidly connecting the inner separation chamber with the primary chamber.

57. The fluid separator as recited in claim 55, wherein the base and the plurality of vanes define a plurality of flow channels, each flow channel being bounded by a separate one of a plurality of pairs of adjacent vanes and having an channel inlet and an channel outlet, each vane being configured to direct flow through at least one channel partially bounded by the vane such that fluid flows radially inward from the channel inlet toward the channel outlet and circumferentially and radially outward from the channel outlet.

58. The fluid separator as recited in claim 57, wherein the base includes a body with a tubular hub portion having first and second ends spaced apart along the base central axis and a disk-like portion extending radially outward from the first end of the hub portion, the hub portion being at least partially disposeable within the separation chamber and each now channel extending radially along the disk-like portion and axially along the hub portion so that fluid contacting a flow channel is directed radially inwardly and then axially and into the separation chamber toward the inner circumferential surface.

59. The fluid separator as recited in claim 55, wherein each vane includes an elongated body having first and second ends and opposing channeling surfaces extending between the first and second ends, each channeling surface being configured to direct fluid contacting the elongated body proximal to the body first end to flow radially inwardly and then simultaneously axially and radially outwardly beyond the body second end.

60. A compressor comprising:
a casing having an interior chamber and an inlet passage extending into the chamber;
a shaft disposed within the casing chamber so as to be rotatable about a central axis;
a least one impeller mounted on the shaft;
a wall disposed within casing chamber and having an end surface and an inner surface extending circumferentially about the central axis and spaced radially outward from the shaft, the inner surface at least partially defining a separation chamber; and
a fluid deflector disposed within the separation chamber between the wall end surface and the impeller, the fluid deflector including:
a base with a central axis, the base being spaced from the wall end surface so as to define a radial port configured to fluidly connect the inlet passage with the separation chamber; and
a plurality of vanes spaced circumferentially about the base central axis, each vane being configured to direct a fluid contacting the vane toward the wall inner surface such that at least a portion of at least one of liquid and relatively dense gas within the fluid directed onto the wall inner surface is separated from the fluid.
